(19) United States
(12) Patent Application Publication
(10) Pub. No.: US 2015/0228940 A1
(43) Pub. Date: Aug. 13, 2015

(54) Backpack-Type Power Supply

(71) Applicant: Hitachi Koki Co., Ltd., Tokyo (JP)

(72) Inventor: Haruhisa Fujisawa, Hitachinaka (JP)

(73) Assignee: Hitachi Koki Co., Ltd., Tokyo (JP)

(21) Appl. No.: 14/420,266

(22) PCT Filed: Aug. 8, 2013
(86) PCT No.: PCT/JP2013/004803

§ 371 Date: Feb. 6, 2015

(30) Foreign Application Priority Data
Aug. 13, 2012 (JP) 2012-179252

(51) Int. Cl. H01M 2/10

(52) U.S. Cl. CPC H01M 2/1005; H01M 2220/30

(57) ABSTRACT

A backpack-type power supply includes: a plurality of secondary battery cells; a case configured to accommodate the plurality of secondary battery cells and adapted to be worn on a user's back; and a cooling fan configured to cool the plurality of secondary battery cells.

### TECHNICAL FIELD

The invention relates to a backpack-type power supply housing rechargeable batteries for power tools.

### BACKGROUND ART

One proposal for providing a portable power supply for power tools and other equipment is to accommodate rechargeable batteries in a waist belt (battery holster) that can be worn about a user's waist (for example, see Japanese Utility Model Application Publication No. H07-3983).

### SUMMARY OF INVENTION

### Technical Problem

A backpack-style power supply worn on the user's back is another possible portable power supply for supplying electricity to power tools and other equipment. The backpack-type power supply can possess a larger capacity than a waist belt power supply because the backpack-type power supply is provided with a housing that can accommodate a larger number of secondary cells (rechargeable lithium-ion batteries, for example) arranged in arrays.

Normally, secondary batteries tend to heat up as they are charging and discharging, and their performance can degrade as their temperature rises. In the battery cell arrangements described above, an amount of temperature increase in a rechargeable battery cell differs according to the location of the cell in the arrays. This nonuniformity in temperature increase can cause irregular degradation of the individual battery cells. If even one of the numerous rechargeable batteries in the backpack-type power supply suffers considerable degradation, the overall discharge capacity of the battery supply may be compromised, preventing the battery supply from realizing its expected discharge capacity.

### Solution to Problem

In view of the foregoing, it is an object of the present invention to provide a backpack-type power supply capable of mitigating non-uniform degradation among its secondary batteries.

In order to attain the above and other objects, the invention provides a backpack-type power supply including: a plurality of secondary battery cells; a case configured to accommodate the plurality of secondary battery cells and adapted to be worn on a user's back; and a cooling fan configured to cool the plurality of secondary battery cells.

With this construction, since temperature increase in the secondary batteries is suppressed, degradation among secondary batteries can be mitigated.

Further, it is preferable that the plurality of secondary battery cells is arrayed in a first direction to form a plurality of battery units, the plurality of battery units being arrayed in a second direction perpendicular to the first direction.

It is preferable that the plurality of battery units is independently detachable from and attachable to the case.

It is also preferable that the plurality of secondary battery cells in each of the plurality of battery units is connected to one another in series, and the plurality of battery units is connected to one another in parallel.

With this construction, even when one or some of the secondary battery cells suffer(s) from considerable degradation, only the battery unit possessing this degraded battery cell(s) can be replaced, thereby facilitating maintenance of the battery units and reducing costs required for replacements.

It is preferable that the cooling fan includes a plurality of fans disposed in one-to-one correspondence with the plurality of battery units. In this case, it is preferable that the backpack-type power supply further includes: a plurality of temperature sensors each configured to detect a temperature of corresponding one of the plurality of battery units; and a control unit configured to control each of the plurality of fans independently of one another based on the temperatures detected by the plurality of temperature sensors.

Further, it is preferable that the control unit is configured to control each of the plurality of fans independently such that a difference in the temperatures among the plurality of battery units remains within a prescribed range.

This construction can mitigate differences among the plurality of battery units at which degradation progresses, thereby preventing the overall discharge capacity from declining prematurely.

It is also preferable that the control unit is configured to halt a specific one of the plurality of fans corresponding to a specific one of the battery units having a lowest temperature among the temperatures of the plurality of battery units.

It is also preferable that the control unit is configured to drive a specific one of the plurality of fans corresponding to a specific one of the battery units having a highest temperature among the temperature of the plurality of the battery units.

This construction can mitigate differences among the plurality of battery units at which degradation progresses, while at the same time conserving power.

It is also preferable that each battery unit has a first end and a second end opposite to the first end in the first direction, the plurality of fans being disposed at the first end and the second end alternately in the second direction.

This configuration can cool the plurality of secondary battery cells with better balance in the first direction.

It is further preferable that: the case has an outer wall, an inner wall opposite to the outer wall and configured to be rested at a user's back, and a pair of side walls each connecting the outer wall to the inner wall, a direction from the outer wall to the inner wall being a third direction perpendicular to the first direction and the second direction; and a combination of the plurality of battery units define a center in the first direction, the second direction, and the third direction; and one of the outer wall, the inner wall, and the side walls is formed with an opening at a position corresponding to the center, the opening being at least one of an air inlet opening and an air outlet opening for establishing an air flow flowing through the center by the cooling fan.

This configuration not only can cool bodies of the secondary battery cells, but can also focus cooling on the secondary battery cells that are more likely to rise in temperature than those secondary battery cells on the periphery. Accordingly, this configuration can also mitigate differences in how degradation progresses among the plurality of secondary battery cells.

It is preferable that the case has a pair of side walls each confronting each end of each of the plurality of battery units in the first direction, and has a bottom wall facing an endmost battery unit in the second direction, one of the side walls and the bottom wall being formed with at least one of an inlet opening and an outlet opening for establishing an airflow by the cooling fan.

This configuration restricts the amount of moisture that enters the case when the power supply is operated in rain or other types of precipitation.

It is further preferable that the case has a wall that rests against the user's back, the wall being formed with at least one of an inlet opening and an outlet opening for establishing an airflow by the cooling fan.

This configuration further restricts a possibility that rain or other foreign matters would enter the case through the opening.

It is also preferable that the case has a wall that rests against the user's back, the wall and the plurality of battery cells defining therebeween a space serving as an air passage extending to or from the cooling fan.

This configuration can reduce the amount of heat generated in the secondary battery cells that is transferred to the user's back through the case. The cooling air flowing through the air passage is also effective in preventing the user's back from becoming hot and sticky.

Further, if the direction of exhausted air can be modified by means for reversing the rotating direction of the fan or the like, heat generated by the secondary cells can be used to warm the user's back when the power supply is being operated in a cold climate or during a cold season.

It is preferable that: the plurality of battery units defines a center in the first direction and in the second direction; and the plurality of battery cells in each battery unit provides first gaps in the first direction between neighboring cells, and the plurality of battery units provide second gaps in the second direction between neighboring battery units, at least one of the first gaps and the second gaps being increased toward the center such that a specific one of the first gap and the second gap located closest to the center is the largest, and another specific one of the first gap and the second gap located farthest from the center is the smallest.

It is further preferable that the backpack-type power supply further includes a plurality of heat distribution control members each disposed between the neighboring battery units and configured to control heat distribution among the plurality of battery units.

It is further preferable that the heat distribution control member includes a partition plate configured to partially partition a space between the neighboring battery units. It is also preferable that the heat distribution control member is made of a thermally insulating material.

Such configurations can direct the cooling air uniformly over the battery cells in the first direction, leading to further effective cooling of the secondary battery cells. Also, heat transfer between neighboring battery units can be restrained, thereby achieving better heat distribution among the secondary battery cells.

It is preferable that the secondary battery cells are lithium-ion secondary battery cells.

The configuration of the present invention described above is effective for any of various secondary batteries known in the art, but demonstrates more remarkable effects with lithium-ion batteries, which are typically susceptible to temperature differences among its secondary battery cells during charging and discharging.

### Advantageous Effects of Invention

The backpack-type power supply according to the present invention can mitigate non-uniform (irregular) degradation among its secondary batteries.

### BRIEF DESCRIPTION OF DRAWINGS

FIG. 1 is a plan view of a backpack-type power supply according to a preferred embodiment of the present invention.

FIG. 2A is a cross-sectional view a case of the backpack-type power supply of FIG. 1 and shows an internal configuration of the case.

FIG. 2B is a cross-sectional side view of the case of the backpack-type power supply of FIG. 1.

FIG. 3A is a cross-sectional view of a case of a backpack-type power supply according to a variation of the present invention.

FIG. 3B is a cross-sectional side view of the case of the backpack-type power supply of FIG. 3A.

FIG. 4A is a cross-sectional view of a case of a backpack-type power supply according to another variation of the present invention.

FIG. 4B is a cross-sectional side view of the case of the backpack-type power supply of FIG. 4A.

### DESCRIPTION OF EMBODIMENT

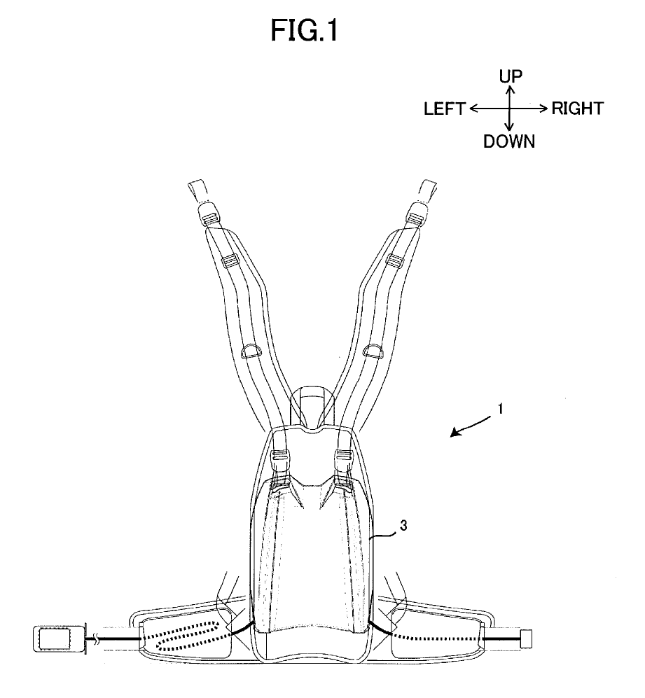

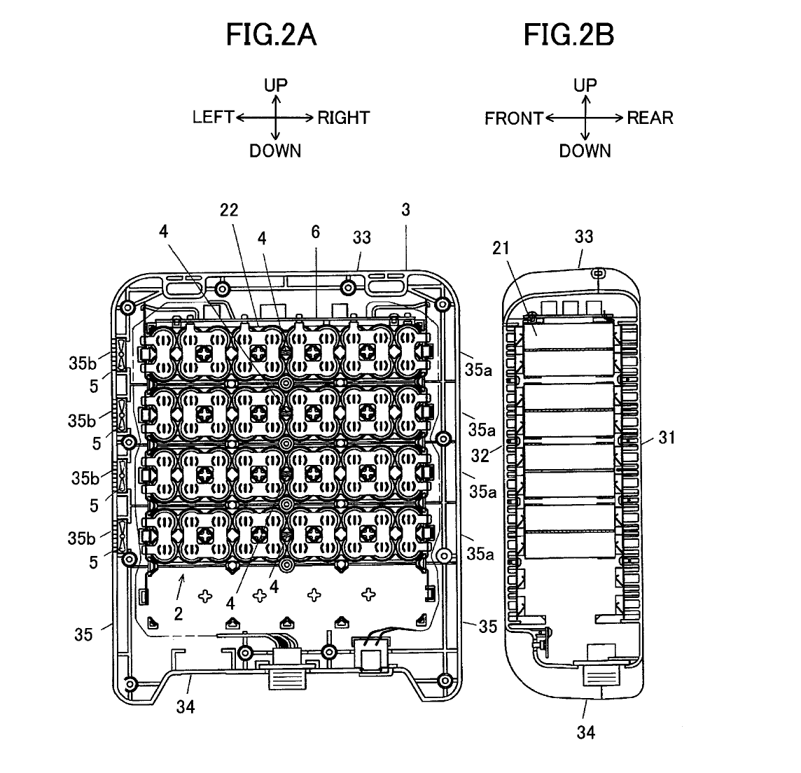

Next, a backpack-type power supply 1 according to a preferred embodiment of the invention will be described while referring to FIGS. 1 through 2B. It should be noted that external pattern and shape of the power supply 1 in FIG. 1 differ slightly from those in other drawings, but are assumed to achieve the same functions in the preferred embodiment.

The power supply 1 according to the preferred embodiment functions to accommodate a battery pack 2 (see FIG. 2) for powering a power tool. The battery pack 2 accommodated in the power supply 1 can be worn on a user's back while the user operates the power tool. As shown in FIGS. 1 through 2B, the power supply 1 also includes a box-like case 3.

The case 3 includes a contact surface 31 that rests against the user's back, an outer surface 32 (see FIG. 2B) opposite the contact surface 31, a top surface 33, a bottom surface 34, and a pair of side surfaces 35.

Four inlets 35a and four outlets 35b are respectively formed in opposing side surfaces 35 at positions confronting respective four battery units 22 described later. In the preferred embodiment, the inlets 35a are formed in the right side surface 35, and the outlets 35b are formed in the left side surface 35, as shown in FIG. 2A.

The case 3 accommodates the battery pack 2, as well as four temperature sensors 4, four cooling fans 5, and a control unit 6.

The battery pack 2 includes a total of eighty lithium-ion secondary cells (hereinafter “battery cells”) 21. More specifically, in this example, the battery pack 2 has four battery units 22, each configured of twenty battery cells 21 arranged in two rows of ten each that are connected in series. That is, the ten battery cells 21 are connected in series in each row, and these two rows of battery cells 21 are connected in parallel to each other in each battery unit 22. The battery units 22 extend in the left-right direction.

One of the temperature sensors 4 is disposed in a center region of each battery unit 22 as an exemplary location that is most susceptible to temperature rise in each battery unit 22. The temperature sensors 4 function to detect temperatures of the corresponding battery units 22 and to output temperature data to the control unit 6.

The cooling fans 5 are arranged in the case 3 each at a position confronting one end (the left end in the preferred embodiment) of the corresponding battery unit 22 in the left-right direction.

The control unit 6 controls each of the cooling fans 5 independently based on the temperature of the corresponding battery unit 22 detected by the corresponding temperature sensor 4. Specifically, the control unit 6 controls each cooling fan 5 such that the temperature of the fan 5 does not go beyond a prescribed temperature. Further, the control unit 6 also controls the cooling fans 5 so that the temperature differential among the four battery units 22 remains within a prescribed range. Possible methods of controlling the cooling fans 5 include adjusting a rotational speed of each cooling fan 5 and reversing a rotational direction of each cooling fan 5 (i.e., reversing an intake/exhaust direction).

By controlling each of the cooling fans 5 so that the temperature differential among the four battery units 22 remains within the prescribed range, the power supply 1 according to the embodiment can mitigate irregular degradation among the battery units 22. Hence, this configuration suppresses a drop in the overall function of the battery cells 21 due to performance degradation in only some of the battery cells 21.

With a conventional technology, an entire battery pack must be replaced if even one of the battery cells in the battery pack has degraded considerably. However, the battery pack 2 according to the preferred embodiment arranges the battery cells 21 in a plurality of battery units 22. Thus, when one of the battery cells 21 suffers from considerable degradation, only the battery unit 22 possessing this degraded battery cell 21 need be replaced, thereby facilitating maintenance of the battery pack 2 and reducing costs required for replacements.

In the above example, the battery cells 21 are lithium-ion secondary cells. Since this type of battery cell is more susceptible to temperature differences during charging and discharging than other types of battery cells, the present invention is particularly effective for this configuration.

Further, in the preferred embodiment, the inlets 35a and outlets 35b are formed in the side surfaces 35. This configuration restricts the amount of moisture that enters the case 3 when the power supply 1 is operated in rain or other types of precipitation.

While the invention has been described in detail with reference to the above embodiment, it would be apparent to those skilled in the art that various changes and variations may be made therein without departing from the scope of the claims.

For example, the control unit 6 in the preferred embodiment described above controls each of the cooling fans 5 such that the temperature differential among the four battery units 22 remains within a prescribed range. However, the control unit 6 may also halt one of the cooling fans 5 corresponding to the battery unit 22 having the lowest temperature or may drive only the cooling fan 5 corresponding to the battery unit 22 having the highest temperature. This configuration obtains the same effects described in the preferred embodiment for mitigating the difference at which degradation of the battery units 22 progresses, while at the same time conserving power.

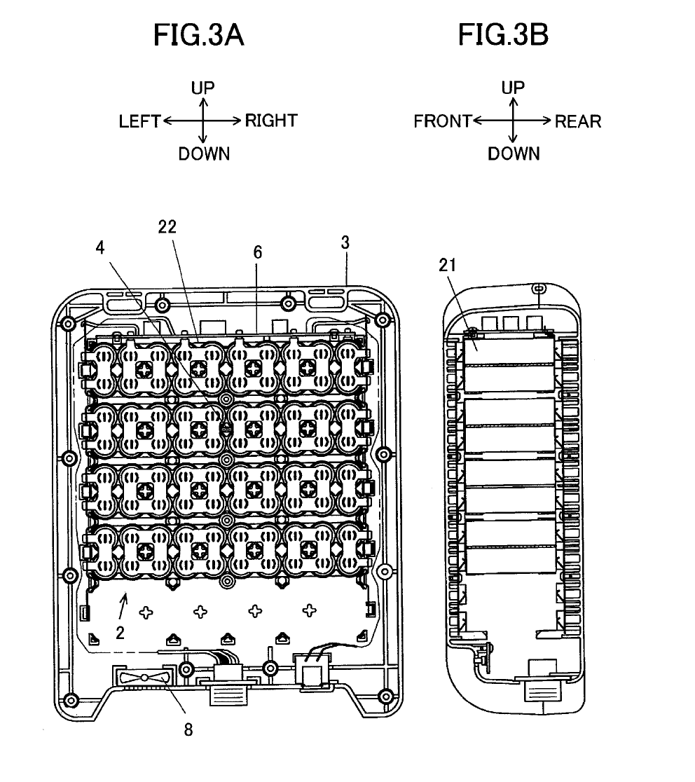

While the case 3 of the preferred embodiment accommodates the plurality of cooling fans 5 each of which is driven independently, the present invention is not limited to this configuration, provided that the fans 5 are located in positions capable of uniformly distributing heat among the secondary cells. For example, the cooling fans 5 may all be driven simultaneously, rather than independently, or the case 3 may be configured as illustrated in FIG. 3A with a single cooling fan 8. It should be apparent to those skilled in the art that requiring fewer components such as fans to attain desired effects is preferable from the perspectives of manufacturing cost, potential for malfunctions and the like, and ease of maintenance, for example.

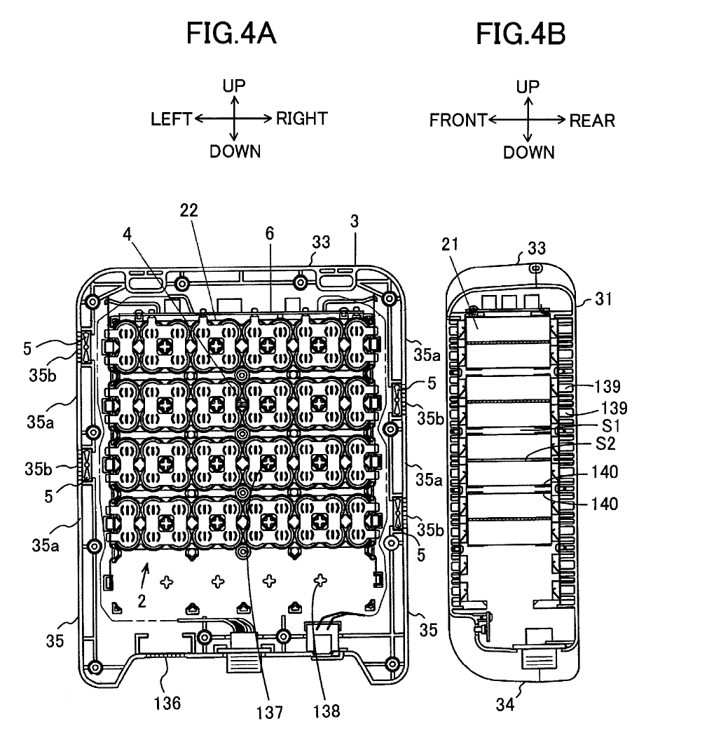

While the four cooling fans 5 are all provided on the left ends of the four battery units 22 in the preferred embodiment, the cooling fans 5 may be arranged on alternate ends of the battery units 22, as shown in FIG. 4A. In this case, the inlets 35a and outlets 35b may also be alternately formed in right and left side surfaces 35 respectively so as to correspond to the alternately-arranged cooling fans 5. This configuration can cool the battery cells 21 with better balance in the left-right direction.

While the inlets 35a and outlets 35b are formed in the side surfaces 35 in the preferred embodiment, there is no particular restriction on the positions of these openings. For example, these openings may be formed in the bottom surface 34 to further restrict moisture from entering the case 3 when working in the rain or other types of precipitation (see reference number 136 in FIG. 4A).

While the inlets 35a and outlets 35b are formed in the left and right side surfaces 35 of the case 3 in the preferred embodiment, these openings may be formed in the contact surface 31 or outer surface 32 at a position generally center of the four battery units 22 (see reference number 137 in FIG. 4A). Here, the “center of the four battery units 22” denotes a position near the center on any one of surfaces of a rectangular parallelepiped configured of the four battery units 22 (i.e., a rectangular parallelepiped formed when the four battery units 22 are combined and treated as one unit).

This configuration not only can cool bodies of the battery cells 21, but can also focus cooling on the battery cells 21 that are more likely to rise in temperature than those battery cells 21 on the periphery. Accordingly, this configuration can also mitigate differences in how degradation progresses in the plurality of battery cells 21.

Alternatively, at least one of the inlets 35a and outlets 35b may be formed in the contact surface 31, which rests against the back of the user during use (see reference numbers 138 in FIG. 4A). Such a configuration is capable of preventing the user's back from becoming hot and sweaty or is capable of warming the user's back using the heat generated by the battery cells 21

Further, a passage for cooling air may also be formed between the contact surface 31 and the four battery units 22 (see reference number 139 in FIG. 4B). This configuration can reduce the amount of heat generated in the battery cells 21 that is transferred to the user's back through the case 3. The cooling air flowing through the passage is also effective in preventing the user's back from becoming hot and sticky.

Note that if the inlets 35a are formed in the contact surface 31, it is preferable that the case 3 be provided with a structure for preventing the case 3 from becoming stuck to the user's back due to suction through the inlets 35a. One method for preventing sticking by suction is to provide bumps on the case 3 and to form openings of the inlets 35a in side surfaces of these bumps so that the openings do not face the user's back. Alternatively, a porous member, such as a sponge, mesh, or the like, may be provided in the openings of the inlets 35a to provide sufficient space for air to flow between the case 3 and the user's back.

It is also preferable to provide heat distribution control members between neighboring battery units 22. Such heat distribution control members may be partition plates or other means for controlling directions of airflow, or insulating means such as a thermally insulating material disposed between neighboring battery units 22. In the example shown in FIG. 4B, partition plates 140 are provided between neighboring battery units 22. Such configurations can direct cooling air uniformly over the battery cells 21, can concentrate the cooling effect in areas with uneven rises in temperature, and can restrain heat transfer between neighboring battery cells 21 and neighboring battery units 22, thereby achieving better heat distribution among the battery cells 21.

Generally, when secondary batteries are densely arranged, battery cells near the center tend to rise in temperature more readily than those positioned on the periphery. Therefore, when a plurality of the battery cells 21 is arrayed in each of a plurality of battery units 22, as in the preferred embodiment, the spacing between neighboring battery cells 21 should be denser at the periphery and gradually more open toward the center. An example of this arrangement is shown in FIG. 4B in which a space 51 (spacing between neighboring battery cells 21 near the center) is larger than a space S2 (spacing between neighboring battery cells 21 at the periphery).

Likewise, the spacing between neighboring battery units 22 may be arranged in a similar manner such that the spacing between neighboring battery units 21 should be denser at the periphery and gradually more open toward the center.

### REFERENCE SIGNS LIST

1: backpack-type power supply
2: battery pack
3: case
4: temperature sensor
5: cooling fan
6: control unit
8: cooling fan
21: battery cell
22: battery unit
31: contact surface
32: outer surface
33: top surface
34: bottom surface
35: side surface
136: opening
137: opening
138: opening
139: air passage
140: partition plate

1. A backpack-type power supply comprising:
a plurality of secondary battery cells;
a case configured to accommodate the plurality of secondary battery cells and adapted to be worn on a user's back; and
a cooling fan configured to cool the plurality of secondary battery cells.

2. The backpack-type power supply according to claim 1, wherein the plurality of secondary battery cells is arrayed in a first direction to form a plurality of battery units, the plurality of battery units being arrayed in a second direction perpendicular to the first direction.

3. The backpack-type power supply according to claim 2, wherein the plurality of battery units is independently detachable from and attachable to the case.

4. The backpack-type power supply according to claim 2, wherein the plurality of secondary battery cells in each of the plurality of battery units is connected to one another in series, and the plurality of battery units is connected to one another in parallel.

5. The backpack-type power supply according to claim 2, wherein the cooling fan comprises a plurality of fans disposed in one-to-one correspondence with the plurality of battery units,
the backpack-type power supply further comprising:
a plurality of temperature sensors each configured to detect a temperature of corresponding one of the plurality of battery units; and
a control unit configured to control each of the plurality of fans independently of one another based on the temperatures detected by the plurality of temperature sensors.

6. The backpack-type power supply according to claim 5, wherein the control unit is configured to control each of the plurality of fans independently such that a difference in the temperatures among the plurality of battery units remains within a prescribed range.

7. The backpack-type power supply according to claim 5, wherein the control unit is configured to halt a specific one of the plurality of fans corresponding to a specific one of the battery units having a lowest temperature among the temperatures of the plurality of battery units.

8. The backpack-type power supply according to claim 5, wherein the control unit is configured to drive a specific one of the plurality of fans corresponding to a specific one of the battery units having a highest temperature among the temperature of the plurality of the battery units.

9. The backpack-type power supply according to claim 5, wherein each battery unit has a first end and a second end opposite to the first end in the first direction, the plurality of fans being disposed at the first end and the second end alternately in the second direction.

10. The backpack-type power supply according to claim 2, wherein the case has an outer wall, an inner wall opposite to the outer wall and configured to be rested at a user's back, and a pair of side walls each connecting the outer wall to the inner wall, a direction from the outer wall to the inner wall being a third direction perpendicular to the first direction and the second direction, and
wherein a combination of the plurality of battery units define a center in the first direction, the second direction, and the third direction; and
wherein one of the outer wall, the inner wall, and the side walls is formed with an opening at a position corresponding to the center, the opening being at least one of an air inlet opening and an air outlet opening for establishing an air flow flowing through the center by the cooling fan.

11. The backpack-type power supply according to claim 2, wherein the case has a pair of side walls each confronting each end of each of the plurality of battery units in the first direction, and has a bottom wall facing an endmost battery unit in the second direction, one of the side walls and the bottom wall being formed with at least one of an inlet opening and an outlet opening for establishing an airflow by the cooling fan.

12. The backpack-type power supply according to claim 2, wherein the case has a wall that rests against the user's back, the wall being formed with at least one of an inlet opening and an outlet opening for establishing an airflow by the cooling fan.

13. The backpack-type power supply according to claim 2, wherein the case has a wall that rests against the user's back, the wall and the plurality of battery cells defining therebetween a space serving as an air passage extending to or from the cooling fan.

14. The backpack-type power supply according to claim claim 2, wherein the plurality of battery units defines a center in the first direction and in the second direction; and
wherein the plurality of battery cells in each battery unit provides first gaps in the first direction between neighboring cells, and the plurality of battery units provide second gaps in the second direction between neighboring battery units, at least one of the first gaps and the second gaps being increased toward the center such that a specific one of the first gap and the second gap located closest to the center is the largest, and another specific one of the first gap and the second gap located farthest from the center is the smallest.

15. The backpack-type power supply according to claim 2, further comprising a plurality of heat distribution control members each disposed between the neighboring battery units and configured to control heat distribution among the plurality of battery units.

16. The backpack-type power supply according to claim 15, wherein the heat distribution control member comprises a partition plate configured to partially partition a space between the neighboring battery units.

17. The backpack-type power supply according to claim 15, wherein the heat distribution control member is made of a thermally insulating material.

18. The backpack-type power supply according to claim 1, wherein the secondary battery cells are lithium-ion secondary battery cells.
